(19) United States
(12) Patent Application Publication
(10) Pub. No.: US 2007/0160867 A1
(43) Pub. Date: Jul. 12, 2007

(54) Magnetic structures, methods of fabricating magnetic structures and micro device incorporating such magnetic structures

(76) Inventors: Wei Beng Ng, Singapore (SG); Takehisa Ishida, Singapore (SG); Hiroyuki Okita, Singapore (SG)

Correspondence Address: William S. Frommer, Esq.;FROMMER LAWRENCE & HAUG LLP, 745 Fifth Avenue, New York, NY, 10151, US

(21) Appl. No.: 11/606,584

(22) Filed: Nov. 30, 2006

(30) Foreign Application Priority Data
Dec. 2, 2005 (SG) 200507703

(51) Int. Cl. B32B 15/01; B32B 15/00; C25D 3/56

(52) U.S. Cl. 428/669; 428/692.1; 428/678; 205/258

(57) ABSTRACT

Highly coercive (out-of-plane) hard magnetic films of cobalt-platinum-phosphorus (CoPtP) composition doped with tungsten (W) were fabricated by direct current (DC) galvanostatic electrodeposition. With the addition of 0.003 mol/L of W in the electrolyte solution for CoPtP, coercivity (Hc) of about 3664-3784 Oe, absolute remanent magnetization (Mr) of 7.8-8.4 memu, and squareness (S) of about 0.53-0.55 were achieved for electroplated CoPtWP single-layered film. Upon annealing in ambient atmosphere at 320° C. for 2 hrs, an improvement in magnetic property was observed with Hc of about 4211-4619 Oe, an absolute Mr of about 7.0-8.4 memu, and a S of about 0.68-0.85. Annealing in air caused oxidation of the CoPtWP leading to a slight decrease in absolute Ms and Mr but a marked improvement in Hc and S due to the presence of non-magnetic metallic oxides formed at the grain boundaries. To achieve higher absolute magnetization, CoPtWP/Au multilayered structures were fabricated by a stepwise plating process. In comparison to a single layered film, a 3-layered structure exhibited a higher absolute Mr of about 14.9 memu, Hc of about 3927 Oe with S about 0.58 after annealing at 320° C. for 3 hrs via a separate annealing sequence.

### FIELD OF THE INVENTION

The present invention relates to magnetic structures, to methods of fabricating the structures, and to devices incorporating such structures.

### BACKGROUND OF INVENTION

The micro-magnets commonly used in micro-magnetic devices are bulk rare earth magnets, including elements of Niobium Iron Boron (Nd-Fe-B) and Samarium Cobalt (SmCo) individually micro-machined using wire electrodischarge machining [1]. However, this fabrication method is not compatible with full integration or batch fabrication since the magnets have to be manually assembled.

Electrochemical processes including electroplating and electrolysis deposition are well-suited to fulfill the requirements of high yield and cost effective processes, but the resulting magnetic properties of electroplated rare earth materials are very much inferior to their bulk counterparts [2, 3]. The main reason for this is the difficulty in effecting electrolytic co-deposition of rare earth metals in pure metallic states from the electrolyte, due to the low equilibrium potential of the rare earth elements [3].

Cobalt platinum (CoPt) is a class of promising hard magnetic films which can be electroplated with relatively good magnetic properties. Theoretically, ordered phases of Co₅₀Pt₅₀ could show a very high coercivity of >10 kOe [4]. However, it is known that when the thickness of a CoPt film exceeds ˜1 μm, its inherently high perpendicular magnetic anisotropy (PMA) rapidly deteriorates with increasing thickness [5]. This is a major drawback for the application of this material in micro-devices since thick films or microstructures are often required for generation of a sufficiently high absolute magnetic field for-micro-actuation purposes.

In a previous patent application (Singapore patent application 200504005-5, filed 24 Jun. 2005, claiming priority from Singapore patent application no. 200503561-3 filed 3 Jun. 2005, neither of which applications had been published by the priority date of the present application) two of the present inventors proposed, among other materials, a magnetic structure for use in a MEMS device and having multiple electroplated layers of Co-Pt-P.

### SUMMARY OF THE INVENTION

The present invention aims to provide a magnetic structure suitable for use in a micro-magnetic device, as well as micro-magnetic devices incorporating the structure. It further aims to provide methods for producing the structure.

In general terms the invention proposes that a magnetic structure is formed by electrodeposition onto substrate of a CoPt layer, with additive tungsten W and phosphorus P (hereafter denoted as CoPtWP).

Preferred values for the composition are 45-95 atomic % cobalt, 0.5-50 atomic % platinum, 0.5-20 atomic % tungsten, and 0.5-10 atomic % phosphorus.

As discussed below in detail, certain embodiments of the invention are magnetic films having high magnetization and coercivity. Specifically, a magnetic film of CoPtWP has been successfully fabricated by an electroplating process under selected process conditions.

In one embodiment of the invention, a multi-layered structure comprising thin individual CoPtWP layers spaced by non-magnetic electrically-conducting layers was fabricated. This makes it possible to achieve higher remnant magnetization, and further makes it possible to avoid the degradation in Hc after annealing which is observed for the case of a thick single layer film. Hence, the embodiment makes possible the use of a thick CoPtWP film (in the form of a multi-layered structure) to generate a sufficiently high absolute magnetization field with high coercivity properties for application in magnetic micro-devices.

Preferably, the thickness of each CoPtWP layer is kept to a maximum of 1.5 μm, more preferably no more than 1 μm, and typically about 0.5 μm.

### BRIEF DESCRIPTION OF THE FIGURES

Preferred features of the invention will now be described, for the sake of illustration only, with reference to the following figures in which:

FIG. 1 is a graph showing the out-of-plane hysteresis curve of an unannealed Cobalt-Platinum-Phosphorus (CoPtP) structure (curve 1), an unannealed CoPtWP structure (curve 2) and an annealed CoPtWP film (at 320° C. for 2 hrs in air) (curve 3).

FIG. 2a is a graph showing the variation of out-of-plane coercivity Hc with film thickness for CoPtP and CoPtWP films.

FIG. 2b is a graph showing the variation of out-of-plane absolute magnetization Mr with film thickness for CoPtP and CoPtWP films.

FIG. 2c is a graph showing the variation of out-of-plane squareness S with film film thickness for CoPtP and CoPtWP films.

FIG. 3 is a graph showing the dependence of magnetic properties of a CoPtWP film on film thickness.

FIG. 4a is a graph showing the variation of out-of-plane coercivity Hc with film thickness before and after annealing in air at 320° C. for 2 hrs for a CoPtWP film.

FIG. 4b is a graph showing the variation of out-of-plane absolute magnetization Mr with film thickness before and after annealing in air at 320° C. for 2 hrs for a CoPtWP film.

FIG. 4c is a graph showing the variation of out-of-plane squareness S with film thickness before and after annealing in air at 320° C. for 2 hrs for a CoPtWP film.

FIG. 5a is a graph showing the variation of out-of-plane coercivity Hc with annealing time at 320° C. in air for 5 samples of CoPtWP films each with about 0.5 μm thickness.

FIG. 5b is a graph showing the variation of out-of-plane absolute magnetization Mr with annealing time at 320° C. in air for 5 samples of coPtWP films each with about 0.5 μm thickness.

FIG. 5c is a graph showing the variation of out-of-plane squareness S with annealing time at 320° C. in air for 5 samples of CoPtWP films each with about 0.5 μm thickness.

FIG. 6 is a schematic diagram showing a CoPtWP/Au multilayered structure which is a second embodiment of the invention.

FIG. 7a is the hysteresis curve of the embodiment of FIG. 6 before (curve 1) and after (curve 2) annealing in air at 320° C. for 3 hrs.

FIG. 7b is the hysteresis curve of the embodiment of FIG. 6 before (curve 1) and after (curve 2) annealing in air at 320° C. for 1 hr separately for the 3 CoPtWP layers.

FIG. 8 is a scanning electron microscopy (SEM) image showing the cross-section of a 3-layered CoPtWP/Au multilayered structure as shown schematically in FIG. 6.

### DETAILED DESCRIPTION OF THE EMBODIMENTS

A method of fabricating a magnetic structure which is an embodiment of the invention will now be described.

In a first step, seedlayers of Cr/Au (20/200 nm) were formed by sputtering on a glass substrate. After activation of the seedlayer with concentrated H₂SO₄ (for about 3 minutes), electrodeposition was carried using a rotating disk electrode (RDE) system via a galvanostat/potentiostat. Ag/KCI was used as the reference electrode while pure platinum wire was used as the anode, to produce a single layer of magnetic material.

In the case of the embodiment, the electrolyte contained tungsten (W). However, a control experiment was performed, as a comparative example, in which exactly the same process was carried out using an electrolyte composition not containing tungsten, thereby producing a layer of Cobalt-Platinum-Phosphorus (“CoPtP”). The composition of the two electrolyte solutions is shown in Table 1. The properties of the electrolyte in the case of the embodiment are given in the third column of the table (“Co-Pt-P-W”), while the properties of the electrolyte in the comparative example are shown in the second column (“Co-Pt-P”). Each of the solutions were adjusted to a pH of 4.5 using NaOH and H₂SO₄. The electroplating conditions of current density and agitation speed are summarized in Table 1.

TABLE 1
Bath Composition and Process Conditions

| | Concentration | | Concentration | |
|---|---|---|---|---|
| Bath Composition | (Co—Pt—P) | | (Co—Pt—P—W) | |
| B(OH)₃ | 0.4 | mol/L | 0.4 | mol/L |
| NaCl | 0.4 | mol/L | 0.4 | mol/L |
| CoCl₂•6H₂O | 0.01 | mol/L | 0.01 | mol/L |
| Na₂PtCl₆•6H₂O | 0.02 | mol/L | 0.02 | mol/L |
| Na₂WO₄•2H₂O | — | | 0.003 | mol/L |
| NaH₂PO₃•2•5H₂O | 2.5 | g/L | 2.5 | g/L |
| Sodium Dodecyl Sulfate | 0.0096 | g/L | 0.0096 | g/L |
| Saccharin (Sodium based) | 1.0 | g/L | 1.0 | g/L |
| Current Density | 25 | mA/cm² | 25 | mA/cm² |
| Agitation (Rotation) | 250 | rpm | 250 | rpm |
| Speed | | | | |

| | | |
|---|---|---|
| Bath Temperature | Room | Room |
| | Temperature | Temperature |
| Bath pH | 4.5 | 4.5 |

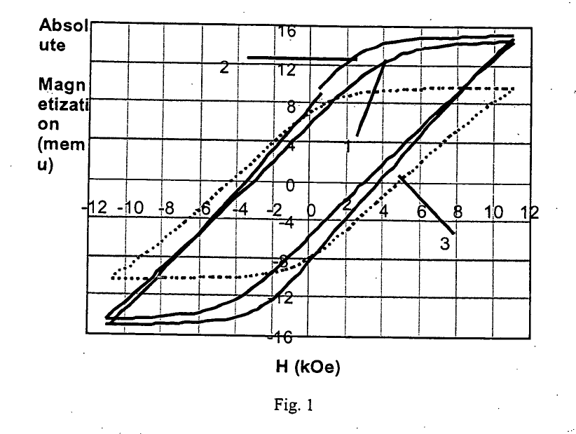

An out-of-plane hysteresis curve of the comparative example, using CoPtP electroplated for 3 min, is shown as the solid curve 1 in FIG. 1. It shows a high coercivity Hc of ˜3043 Oe with absolute remanent magnetization Mr of ˜5.8 memu and a squareness S of ˜0.4.

By contrast, a typical hysteresis curve of the embodiment of the invention is shown by the curve 2 in FIG. 1. As described above, in the embodiment non-magnetic tungsten W was electroplated in-situ with CoPtP by including 0.003 mol/L of W in the CoPtP electrolyte solution. A marked improvement in magnetic properties of CoPtP-W was observed with Hc in the range (among 5 samples) of about 3664-3784 Oe, absolute Mr 7.8-8.4 memu, and S of about 0.53-0.55, for films of 0.5 μm thickness. A broadening in the hysteresis curve is caused by the addition of W, hence leading to higher Hc and Mr. The mechanism of Hc enhancement by additive W is believed to be caused by the precipitation of W at the grain boundaries, building on the grain decoupling effect contributed by precipitation of P also at the grain boundaries. Thus, the resulting structure consists of isolated magnetic CoPt grains surrounded by non-magnetic or weakly magnetic boundaries made up mostly by W and P. Such microstructural formations increase the energy barrier for magnetic realignment of the domains and thereby increase the overall coercivity Hc of the films, making them magnetically hard. Although Pt is also present in the system, it should be noted that it behaves differently from W in that the former is able to alloy easily with Co hence forming a CoPt alloy which has a very much higher Hc as compared to pure Co (generally Hc about 500 Oe). Hence the enhancement of Hc in the present system (as compared to pure Co) is two-fold, one arising from the increased magnetocrystalline anisotropy achieved by the alloying effect of Pt, the other from the grain decoupling achieved by W concentration at the grain boundaries.

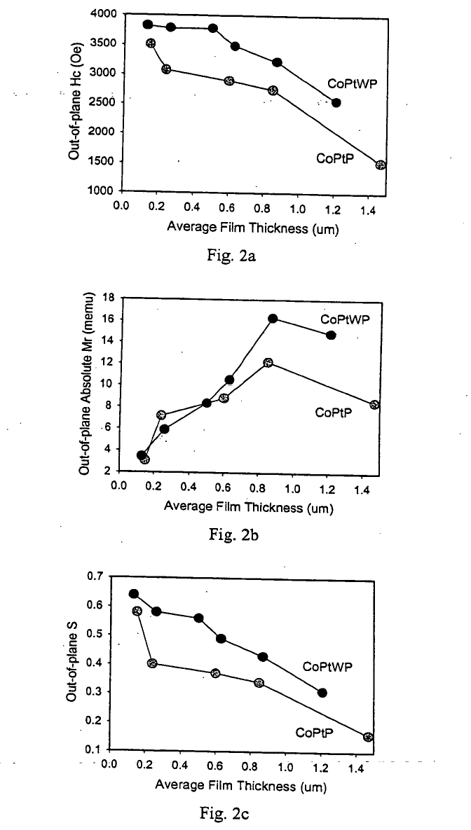

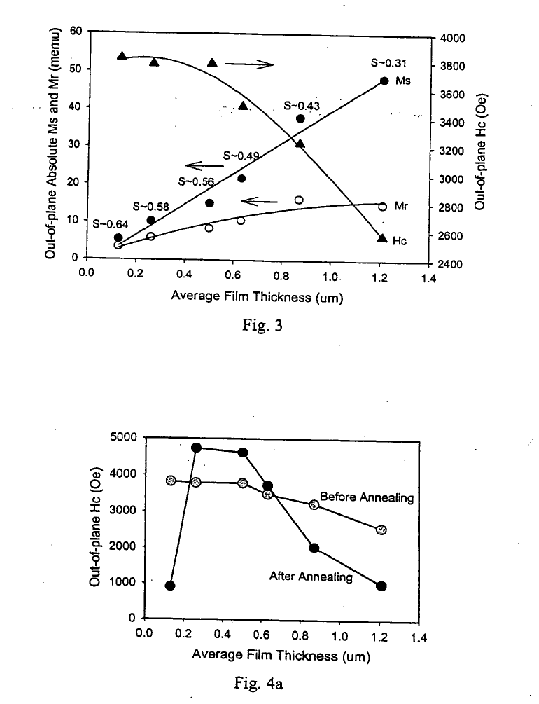

The effect of additive W in the CoPtP system was further investigated as a function of film thickness as shown in FIGS. 2(a), 2(b) and 2(c). Out-of-plane Hc and S decrease with increasing film thickness for both CoPtP and CoPtWP. Nevertheless, at all film thicknesses, CoPtWP exhibits a higher Hc and S than CoPtP. As expected, absolute Mr (as well as Ms) increases with film thickness since there are more magnetic materials with thicker films. However, the increase in absolute Mr seems to reach a plateau beyond a film thickness of about 1 μm as shown in FIG. 3 (where the indicated points are experimental results and the lines are interpolations produced using them) most probably due to decreasing S with increasing thickness since Mr is related to S by Mr=S×Ms.

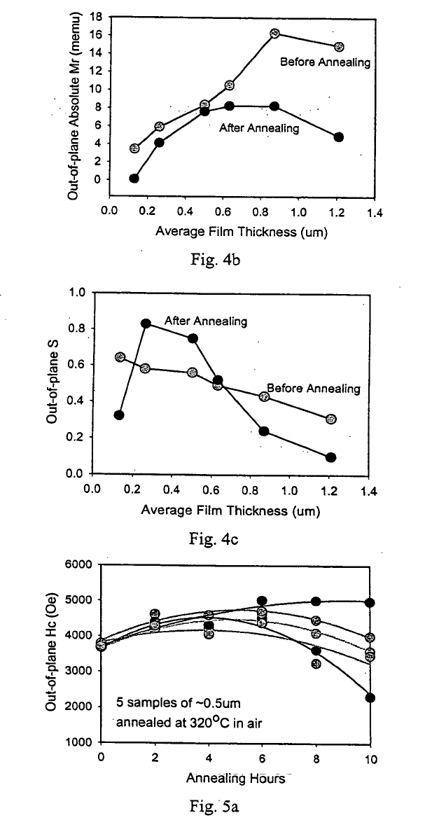

FIGS. 4(a), 4(b) and 4(c) show the thermal stability of CoPtWP as a function of film thickness upon annealing at 320° C. for 2 hrs in air atmosphere. The results shown in FIG. 4 indicate that there is a range of film thickness in which annealing provides further improvement of the magnetic properties. It is noted that when the thickness is in the range of about 0.2 to 0.6 μm (and particularly 0.3 to 0.6 μm), Hc and S improve while a slight drop in absolute Mr was observed. As can be seen from the hysteresis curve 3 in FIG. 1 (shown dotted) for a sample of thickness about 0.5 μm after plating for 3 min, there is a sharp drop in absolute Ms indicating the formation of non-magnetic metallic oxides such as cobalt oxides. At the same time, there is a broadening of the hysteresis curve leading to higher Hc beyond 4 kOe and S beyond 0.6. The further enhancement in Hc by postannealing is believed to be caused by the formation of metallic oxides such as tungsten oxides at the grain boundaries leading to a similar effect of grain decoupling. Hence, it seems that formation of non-magnetic oxides can act as a more effective grain decoupling agent.

The effect of prolonged annealing time at the same temperature is shown in FIGS. 5(a) to 5(c) for 5 separate samples processed with parameters shown in Table 1 under the same conditions i.e. a plating time of 3 min. For each sample, experimental points are given for each of a number of annealing times, and a respective line is provided interpolating those points. Further improvement in Hc and S continue to be observed until beyond about 6 hrs upon which a decrease in magnetic properties were observed. Due to inevitable oxidation caused by annealing in air, Ms continues to drop as the annealing time increases until when it dropped below the original unannealed Mr level beyond which Mr is greatly affected. From FIG. 4(b), it seems that Mr is least affected when the film thickness is about 0.5 μm. The fluctuation between the 5 samples of FIG. 5, especially after 6 hrs of annealing, is most probably due to the fluctuation in the film thickness which could affect the magnetic properties as exemplified in FIG. 3. The reproducibility of film thickness is often complicated by the evolution of hydrogen bubbles on the substrate surface during the plating process since cathodic reduction of metal ions to metals is competitive with the reduction of hydrogen ions to hydrogen gas. If the bubbles could not be eliminated fast enough from the substrate surface, it could easily prevent the subsequent effective deposition of metallic materials. Generally this problem could be alleviated by using a higher agitation speed during plating.

To summarize, it was possible to produce a single layer of CoPtWP, due to grain decoupling caused by the formation of non-magnetic metallic oxides at grain boundaries, exhibiting an Hc improved to ˜4211-4619 Oe with absolute Mr of ˜7.0-8.4 memu, and S of ˜0.68-0.85, after annealing at 320° C.

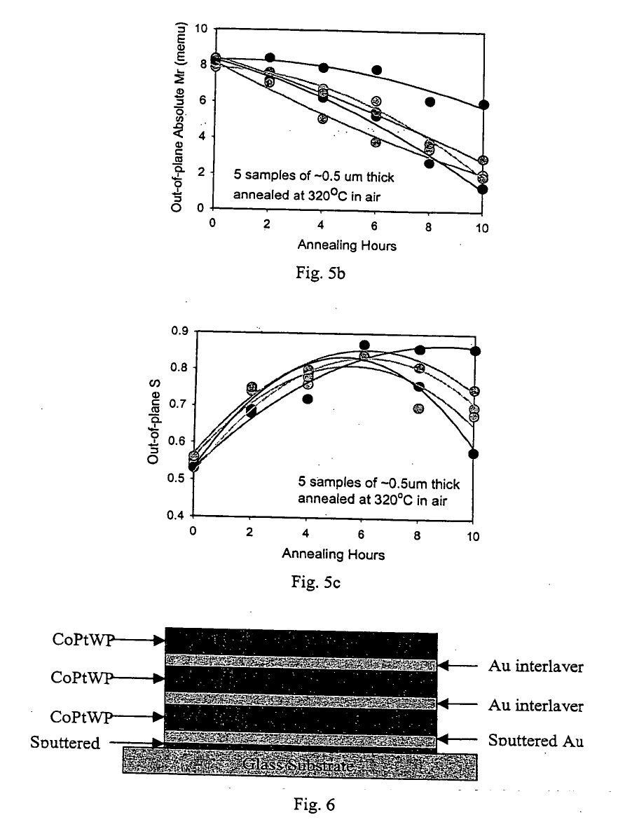

Although higher absolute remnant magnetic flux (i.e. Mr) could be achieved with thicker films, a thick CoPtWP film suffers drastic magnetic degradation after annealing at 320° C. Hence, with the aims of increasing Mr and avoiding the annealing degradation, the effects of performing annealing during the formation of the multilayer structure was studied experimentally. For a preliminary study, a 3-layered multilayered structure with Au interlayers was fabricated. Specifically, in a second embodiment of the invention a first layer of CoPtWP is deposited by the steps described above in relation to the first embodiment of the invention, but following the deposition of the CoPtWP magnetic layer, in this second experiment a layer of gold (Au) was plated over the magnetic layer. A non-cyanide Au electrolyte solution was used for plating the Au interlayer at a current density of 25 mA/cm², pH 4.5 and an agitation speed of 500 rpm. Under these plating conditions, the film thickness of each Au interlayer was about 200 nm. As in the case of the sputtered Au seedlayer, each plated Au interlayer was activated by concentrated H₂SO₄ (for about 3 minutes) before plating onto it of an additional magnetic CoPtWP layer (or, in the case of the comparative example, a CoPtP magnetic layer). This process was repeated, to form a multi-layered structure comprising three layers of magnetic CoPtWP interleaved by two layers of plated gold (Au). This structure is as shown schematically in FIG. 6.

The annealing study was carried out in air at 320° C. via two different approaches. One of the approaches was a one-time annealing of the 3-layered structure at 320° C. for 3 hrs, while the other approach was to anneal separately the individual CoPtWP film at 320° C. for 1 hr after each was plated on and before the subsequent plating of the next layer.

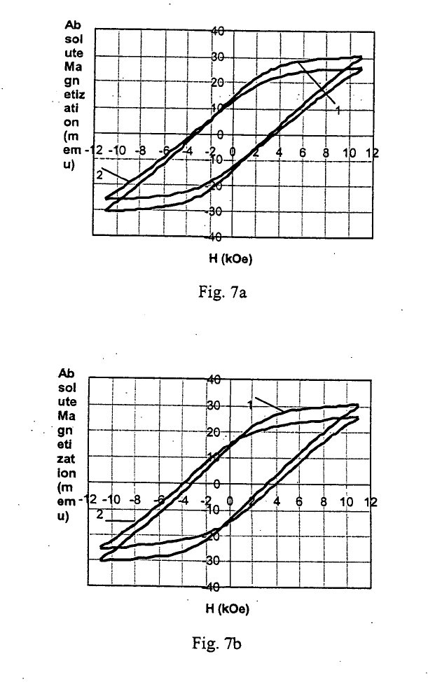

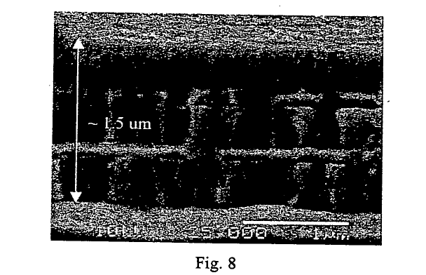

FIG. 7 shows the hysteresis curves of 3-layered structures before and after annealing via the two approaches. In each case, curve 1 shows the properties before annealing, while curve 2 shows them afterwards. As can be observed from curves 1 and 2, Hc was maintained above 3 kOe after annealing of an about 1.5 μm thick multilayered film with cross-sectional view as shown in SEM picture of FIG. 8. Both annealing methods enhanced the magnetic properties of multilayered structure in terms of Hc and S with little change in absolute Mr. However, it can be observed that separate annealing of individual CoPtWP layers induced a slightly higher enhancement in Hc from ˜3 kOe to 3.9 kOe, as compared to 3.5 kOe by the one-time annealing process. Specifically, a 1.5 μm thick 3-layered CoPtWP/Au structure exhibited high absolute Mr of ˜14.9 memu with a high Hc of ˜3927 Oe and S ˜0.58 after annealing at 320° C. for 3 hrs following an annealing sequence with three separate stages just after the formation of the respective layers. We have understood from the earlier investigation of a single CoPtWP film that formation of non-magnetic metallic oxides at the grain boundary is responsible for the improvement in Hc. Hence, the difference in the annealing effect may be attributed to the lack of grain boundary oxidation for the two buried layers of CoPtWP in the case of one-time annealing. Table 2 shows a comparison of the effect of annealing on the magnetic properties of single and multilayered films.

TABLE 2
Effect of annealing on magnetic properties
of single and multilayered films

| | Thickness | Annealing | | Abs. Mr | |
|---|---|---|---|---|---|
| Films | (μm) | Condition | Hc (Oe) | (memu) | S |
| Single | 1.2 | Un-annealed | 2569 | 14.89 | 0.31 |
| Layer | | | | | |
| Single | 1.2 | 320° C. × 2 hrs | 1002 | 4.90 | 0.10 |
| Layer | | | | | |
| 3-Layered | 1.5 | 320° C. × 3 hrs × | 3553 | 12.26 | 0.50 |
| | | 1 time | | | |
| 3-Layered | 1.5 | 320° C. × 1 hr × | 3927 | 14.92 | 0.58 |
| | | 3 times | | | |

References
1. C. Yan, X. Zhao, G. Ding, C. Zhang, and B. Cai, “Axial flux electromagnetic micromotor”, J. Micromech. Microeng., 11 (2001) 113-117.
2. H. Karai, K. Hara, and Y. Yao, Extended Abstract of the 72nd Meeting of the Metal Finishing Society of Japan, (1985) 30.
3. Y. Sato, T. Takazawa, M. Takahashi, H. Ishida, and K. Kobayakawa, “Electrolytic Preparation of Sm-Co Thin Films and their Magnetic Properties”, Plating and Surface Furnishing, (1993) 72-74.
4. K. R. Coffey, M. A. Parker, J. K. Howard, IEEE Trans. Magn., 31 (1995) 2737.
5. P. L. Cavallotti, N. Lecis, H. Fauser, A. Zielonka, J; P. Celis, G. Wouters, J. Machado da Silva, J. M. Brochado Oliveira, M. A. Sa, Surf. Coat. Tech. 105 (1998) 232.

1. A magnetic structure comprising a substrate and at least one layer of magnetic material deposited on the substrate, the magnetic material containing 45-95 atomic % cobalt, 0.5-50 atomic % platinum, 0.5-20 atomic % tungsten, and 0.5-10 atomic % phosphorus.

2. A magnetic structure according to claim 1 in which the structure comprises a plurality of layers of said magnetic material.

3. A magnetic structure according to claim 2 in which the plurality of layers are interleaved with non-magnetic layers.

4. A magnetic structure according to claim 1 in which the or each layer containing cobalt, platinum, tungsten and phosphorus comprises crystal grains having a relatively low level of tungsten, divided by grain boundaries containing a relatively higher level of tungsten.

5. A method of forming a magnetic structure according to claim 1, comprising electroplating the at least one layer of magnetic material onto the substrate in an electrochemical bath.

6. A method according to claim 5 in which the composition of the electrochemical bath includes 0.001 -0.5 mol/liter of Co2+ions, 0.001 -0.5 mol/liter of PtC162-ions, 0.001-0.5 mol/liter of WO42-ions, and 0.001- 0.5 mol/liter of HPHO3-ions.

7. A method according to claim 5 in which the pH of the chemical bath is between 4.0 and 5.0.

8. A method according to claim 5 in which the electroplating is carried out at a current density of 20-30 mA/cm².

9. A method according to claim 5 in which the substrate carries a seed layer of gold with a (111) crystal orientation.

10. A method according to claim 5 further including a step in which the layer of magnetic material is subjected to annealing in the ambient atmosphere at 100-500° C.

11. A method according to claim 5 comprising at least one further step of electroplating a further layer of magnetic material on said substrate.

12. A method according to claim 11 in which a respective step of subjecting the structure to annealing is performed after the formation of each successive further layer of magnetic material.

13. A micro-device incorporating a magnetic structure according to claim 1.

14. A micro-device according to claim 13 which is a MEMS device.
